(19) United States
(12) Patent Application Publication
(10) Pub. No.: US 2026/0110160 A1
(43) Pub. Date: Apr. 23, 2026

(54) DEVICES FOR USE IN THE KITCHEN AND RELATED METHODS

(71) Applicant: Zhongwei Lu, Amissville, VA (US)

(72) Inventor: Zhongwei Lu, Amissville, VA (US)

(21) Appl. No.: 19/356,346

(22) Filed: Oct. 13, 2025

Related U.S. Application Data
(60) Provisional application No. 63/708,931, filed on Oct. 18, 2024.

(51) Int. Cl. E03C 1/186; B65F 1/00; B65F 1/14; B65F 1/16

(52) U.S. Cl. CPC E03C 1/186; B65F 1/0053; B65F 1/16; B65F 2001/1489; B65F 2250/112; B65F 2250/114

(57) ABSTRACT

Devices for use in the kitchen are described, including food waste holders and bottle openers.

### TECHNICAL FIELD

The present disclosure relates to devices that may be used in a kitchen, such as a removable food waste holder and a multi-functional, kitchen support structure, for example.

### INTRODUCTION

This section introduces aspects that may help facilitate a better understanding of the disclosure. Accordingly, the statements of this section are to be read in this light and are not to be understood as admissions about what is, or what is not, prior art.

This section introduces aspects that may be helpful to facilitate a better understanding of the described disclosure(s). Accordingly, the statements in this section are to be read in this light and are not to be understood as admissions about what is, or what is not, in the prior art.

Food waste is usually composed of a mixture of fruit peels, vegetable and food bits, meat, and bones. Many times food waste is combined with other household wastes such as plastic food wrappings or coverings, tissues, and other waste papers in the same trash can or receptacle. It is difficult then to separate such combined wastes, in particular, when someone wishes to separate and use food waste as a source of fertilizer, for example.

Accordingly, it is desirable to provide devices and related methods that allow for the separation of food waste in the kitchen.

### SUMMARY

The inventors describe various exemplary, inventive devices and methods for use in the kitchen. For example, one device may comprise a removable food waste holder for a kitchen sink comprising a plurality of side walls, a bottom and a hingeable top forming a chamber to hold food waste, wherein the bottom comprises a plurality of openings to allow liquid to drain out of the holder and into the sink.

A related method for collecting food waste within a kitchen sink may comprise inserting the food waste holder into a kitchen sink, where the holder may comprise a plurality of side walls, a bottom and a hingeable top forming a chamber to hold food waste, and wherein the bottom may comprise a plurality of openings to allow liquid to drain out of the holder and into the sink, lifting the holder and allowing the liquid to drain out of the openings and emptying the chamber.

Yet another device may be a support structure attached to a kitchen countertop. Such a support structure may comprise at least one supporting pole, one or more supporting arms connected to the at least one pole and further comprising at least one supporting ring connected to each arm, and at least one compartment supported by each of the rings for holding bottle caps, scrubbers, and/or food waste.

Another embodiment of a removable food waste holder for a kitchen sink may comprise: a plurality of adjustable side walls, an adjustable bottom structure and an adjustable hingeable top cover forming a chamber to hold food waste, wherein the bottom structure comprises a plurality of openings to allow liquid to drain out of the holder and into the sink. wherein each of the plurality of adjustable side walls is composed of a stainless steel or a non-stainable plastic.

Exemplary dimensions of each of the adjustable hingeable top cover, adjustable bottom structure, and adjustable side walls, may be variable in width, depth and/or length to allow the holder to fit within a kitchen sink. For example, some exemplary dimensions of the holder are 8″ in width, 7″ in depth and 171/2″ in length or 6″ in width, 6″ in depth and 151/2 in length.

Yet further the holder may include one or more curved sub-walls.

One exemplary shaped holder may be rectangular in shape. Alternatively, the holder may be shaped as a square, oval, or circular.

In addition, one or more of the side walls may comprise a top, circumferential adjustable rim portion configured to rest upon ridges of the kitchen sink, where the rim portion may comprise a width of one inch.

In addition to structures, the disclosure provides a method for collecting food waste within a kitchen sink, where such a method may comprise: inserting a food waste holder into a kitchen sink, the holder comprising a plurality of side walls, a bottom and a hingeable top forming a chamber to hold food waste, wherein the bottom comprises a plurality of openings to allow liquid to drain out of the holder and into the sink; lifting the holder; and allowing the liquid to drain out of the openings and emptying the chamber.

In addition to holders the disclosure describes exemplary support structures attached to a kitchen counter-top. Such structures may comprise: at least one supporting pole, one or more supporting arms connected to the at least one pole; at least one supporting ring connected to each supporting arm; and at least one compartment supported by each of the rings for holding bottle caps, scrubbers, and/or food waste.

In an embodiment, the pole, arm and ring may be composed of a stainless steel.

In an embodiment, the compartment may comprise a threaded bottle cap storage compartment, may be cylindrical in shape and may be composed of a stainless steel or non-stainable plastic.

Another method for supporting a compartment attached to a kitchen counter-top may comprise: connecting at least one structure to a kitchen counter-top, the structure comprising at least one supporting pole, one or more supporting arms connected to the at least one pole and at least one supporting ring connected to each arm, andconnecting at least one compartment to each of the rings to hold bottle caps, scrubbers and/or food waste.

Yet further, a related method for supporting a compartment attached to a kitchen counter-top may comprise connecting at least one structure to a kitchen counter-top, the structure comprising at least one supporting pole, one or more supporting arms connected to the at least one pole and at least one supporting ring connected to each arm, and connecting at least one compartment to each of the rings to hold bottle caps, scrubbers and/or food waste, for example.

The inventive devices and corresponding methods described above are just some of the inventive devices and methods that will be apparent from the discussion herein.

### BRIEF DESCRIPTION OF THE DRAWINGS

The present disclosure is illustrated by way of example and is not limited by the accompanying figures in which like reference numerals indicate similar elements and in which:

FIG. 1A depicts a simplified image of a removable food waste holder configured to fit within a kitchen sink according to one embodiment of the present disclosure.

FIG. 1B depicts a simplified image of a kitchen sink without a removable food waste holder.

FIG. 2 depicts a simplified image of a multi-functional, kitchen support structure configured to be attached nearby a kitchen sink according to one embodiment of the present disclosure.

FIG. 3A depicts a simplified image of the bottom view of the multi-functional, kitchen support structure in FIG. 2 according to one embodiment of the present disclosure.

FIGS. 3B and 3C depict simplified images of another alternative multi-functional, kitchen support structure according to a second embodiment of the present disclosure.

FIG. 4 depicts a simplified image of a side view of the cap opener in FIG. 2 according to one embodiment of the present disclosure.

FIGS. 5A and 5B depict views of a hingeable cover according to an embodiment of the disclosure.

Specific embodiments of the present disclosure are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a clearer presentation of embodiments may be achieved.

Simplicity and clarity in both illustration and description are sought to effectively enable a person of skill in the art to make, use, and best practice the present disclosure in view of what is already known in the art. One skilled in the art will appreciate that various modifications and changes may be made to the specific embodiments described below without departing from the spirit and scope of the present disclosure. Thus, the specification and drawings are to be regarded as illustrative and exemplary rather than restrictive or all-encompassing, and all such modifications to the specific embodiments described below are intended to be included within the scope of the present disclosure.

### DETAILED DESCRIPTION OF EXEMPLARY EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

As used herein and in the appended claims, the term “comprises,” “comprising,” or variations thereof are intended to refer to a non-exclusive inclusion, such that a process, method, article of manufacture, or apparatus (e.g., a kitchen device) that comprises a list of elements does not include only those elements in the list, but may include other elements not expressly listed or inherent to such process, method, article of manufacture, or apparatus.

The terms “a” or “an”, as used herein, are defined as one, or more than one. The term “plurality”, as used herein, is defined as two, or more than two. The term “another”, as used herein, is defined as at least a second or more.

Unless otherwise indicated herein, the use of relational terms, if any, such as “first” and “second”, “top” and “bottom”, “back” and “front”, and “left” and “right” and the like are used solely to distinguish one view, entity or action from another view, entity or action without necessarily requiring or implying any actual such relationship, order or importance between such views, entities or actions. Similarly, the use of positional terms such as vertical or horizontal are used solely to distinguish one position from another position, where “vertical” means a position in the y-axis or upwards from the ground or a surface without necessarily requiring or implying any actual position or importance.

The terms “including” and/or “having”, as used herein, are defined as comprising (i.e., open language).

As used herein the phrase “configured to” means “sized to” and/or “functions to” unless the context or knowledge of one skilled in the art indicates otherwise.

To the extent any dimension, weight, size, percentages, or operating parameters are described herein or shown in the figures (collectively ‘parameters”), it should be understood that such parameters are non-limiting and merely exemplary to allow those skilled in the art to understand the inventive embodiments described herein.

Similar reference numbers may denote similar components and/or features throughout the attached drawings.

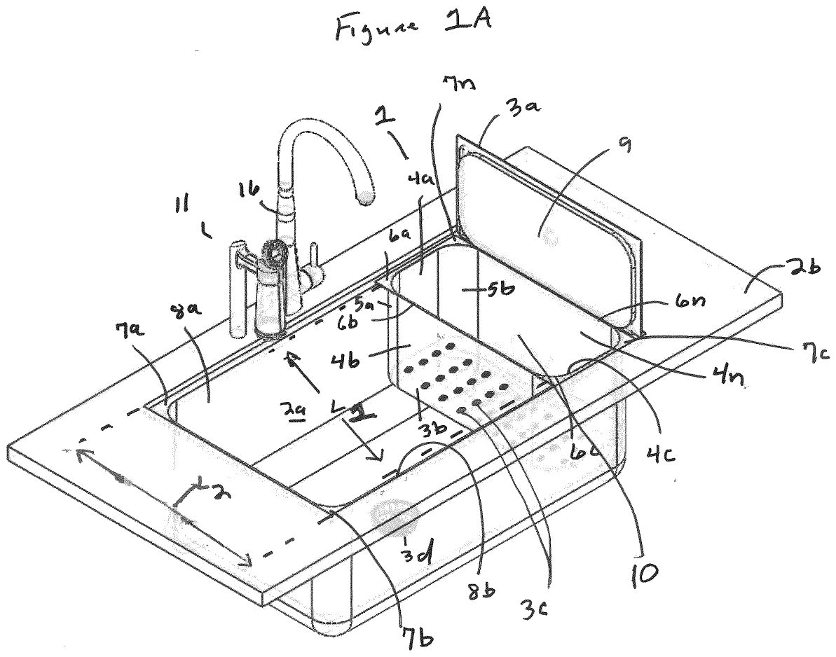

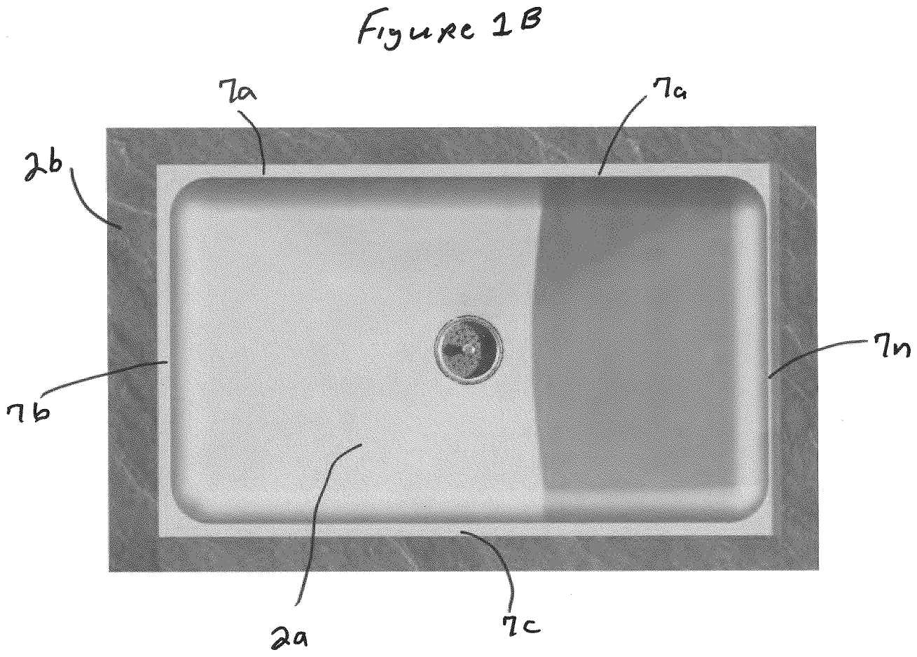

Referring to FIG. 1A there is depicted a simplified image of a removable food waste holder 1 configured to fit within a kitchen sink 2a according to one embodiment of the present disclosure. Though only a single removable food waste holder 1 is shown in FIG. 1A it should be understood that more than one holder 1 may be configured within the sink 2a depending on the size of the sink 2a and/or on the size of the holder 1. For example, one removable food waste holder may be used to hold fruit and vegetable peels, used coffee grounds, eggshells, etc., while a second removable food waste holder may be used to hold meat, bone, and/or animal waste. In an embodiment, a plurality of food waste holders, each dedicated to a separate type of food waste may be configured within the sink 2a. The ability to collect and separate several types of food waste allows a user of the holders to utilize food waste for a number of additional applications, such as organic fertilizer for growing fruits and vegetables, for example.

In an embodiment, the removable food waste holder 1 may comprise an adjustable and hingeable top cover 3a, adjustable bottom structure 3b one or more adjustable side walls 4a to 4n (where “n” indicates a last wall). In an embodiment, each of the walls may be composed of a stainless steel or another similar metal or a non-stainable plastic. By “adjustable” is meant that the dimensions of each of the hingeable top cover 3a, bottom structure 3b, and walls 4a to 4n may vary in width, depth and/or length to allow the holder 1 to fit within a kitchen sink.

As illustrated in FIG. 1A the walls 4a to 4n may include one or more curved sub-walls 5a,5b (only two are shown in FIG. 1A, but that is merely exemplary) Though shown as curved it should be understood that each of the sub-walls 5a,5b may be shaped differently (flat, curved). Together the top, bottom and walls form a chamber 10 to hold food waste. Though the holder 1 in FIG. 1A is depicted as a rectangular-shaped holder 1, this is merely exemplary. In alternative embodiments the holder 1 comprising a top, bottom and one or more walls may be configured in a number of shapes in order to fit within a kitchen sink 2a (e.g., square, oval, circular). Further, the dimensions of the top. bottom and one or more walls may also be selected in order to fit within a given kitchen sink. Some non-limiting examples of dimensions may be 8″ wide, 7″ deep and 171/2″ in length with a 1″ rim width or 6″ in width, 6″ deep and 151/2 in length with a 1″ wide rim to name just two of many different sizes) As shown, one or more of the walls 4a to 4n may each comprise a top, circumferential adjustable rim portion 6a to 6n (“rim portions” for short), respectively, where one or more of the adjustable rim portions 6a to 6n are configured to rest upon ridges or surfaces 7a to 7n (hereafter ridges); of the kitchen sink 2a. The ridges 7a to 7n are also shown in FIG. 1B where the holder 1 has been removed.

Again, by “adjustable” is meant that the dimensions of each of the rim portions 6a to 6n may vary in width, depth and/or length to allow the holder 1 to fit within a kitchen sink.

In the embodiment depicted in FIGS. 1A and 1B the interior ridges or top surfaces 7a to 7n (hereafter “ridges”) of the sink 2a are positioned below the counter-top 2b, thereby forming the ridges. Accordingly, in FIG. 1A the respective rim portions 6a, 6c rest upon respective interior top ridges 7a,7c of the sink 2a.

In an embodiment a rim portion may be configured on the top of each wall 4a to 4n, or alternatively be configured only on the top of those walls which rest upon ridges 7a to 7n of the sink 2a (e.g., two sides). More particularly, though the exemplary food waste holder 1 shown in FIG. 1A depicts rim portions 6a to 6n on the top of all walls 4a to 4n, only those walls which rests upon the ridges 7a to 7n of the sink 2a may include rim portions.

To allow the holder 1 to fit within the dimensions of the sink 2a while permitting one or more of the rim portions to rest on one or more of the ridges 7a to 7n the lengths L1 of the top rim portions 6b, 6n of walls 4b, 4n may be greater than the length L2 that separates the interior walls 8a, 8b of the sink 2a.

In an embodiment, the hingeable top 3a may comprise an internal sealant structure 9 that prevents food odors from escaping the inside chamber 10 of the holder 1 and prevents rodents from accessing the food waste in the chamber 10. Upon closing the top 3a onto the rim portions 6a to 6n the perimeter of the sealant structure 9 contacts the top, internal wall sections of walls 4a to 4n to form a seal that prevents rodents from accessing food waste within the chamber 10 and prevents food odors from escaping the chamber 10.

In an embodiment, the bottom 3b may comprise openings 3c to allow liquid from food waste placed within the chamber 10 to flow into the drain 3d of the sink 2a before the holder 1 is removed from within the interior of the sink 2a. In an embodiment, the holder 1 may be emptied by removing the holder 1 and then emptying the food waste within the chamber 10 into a food waste container, such as those described in U.S. patent application Ser. No. 18/227,278.

As noted above the surfaces 7a to 7n may form ridges. In an embodiment, the holder 1 may be moved along one or more of the ridges 7a to 7n (e.g., ridges 7a,7c) of the sink 2a (from right to left, and left to right, etc., .) as the user applies force to slide the top rim portions 6a,6c along the ridges 7a,7c. In non-limiting embodiments each of the rim portions 6a to 6n may be composed of a rubber padding or a stainless steel to name just two of the many materials that may be used.

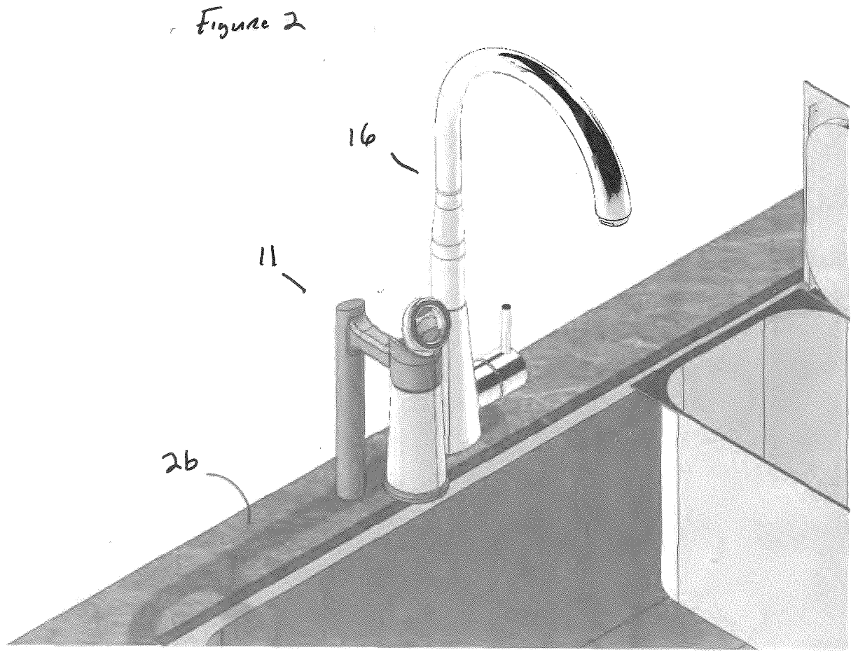

FIG. 1A also depicts an exemplary multi-functional, kitchen support structure 11 configured to be attached to the kitchen counter-top 2b nearby the sink 2a. FIGS. 2, 3A and 4 show additional views of the support structure 11. It should be noted that while the support structure 11 is shown attached to the counter-top 2b and close to the water faucet 16 in FIGS. 1A and 2, this is merely exemplary. In additional embodiments the support structure 11 may be configured at other positions on the counter-top 2b rather than close to the faucet 16. Further, the support structure 11 may be configured to be attached to another surface instead of to the kitchen counter-top 2b.

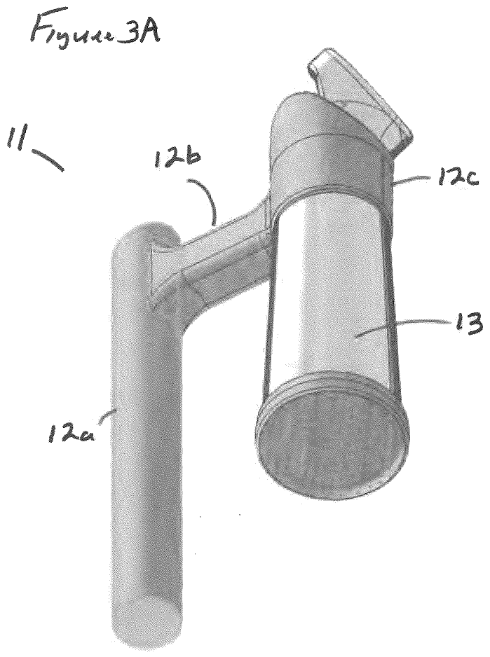

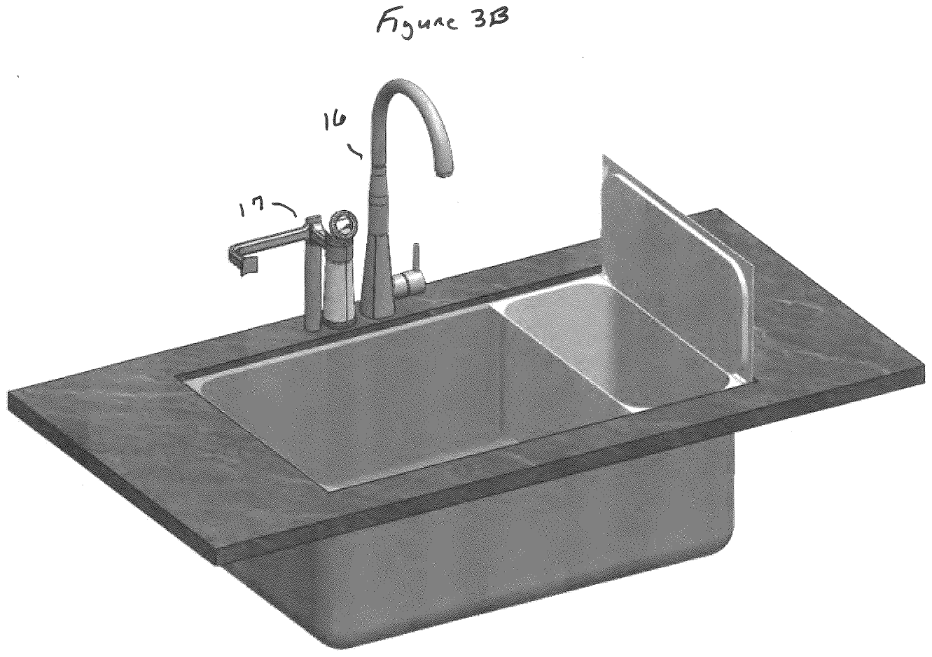

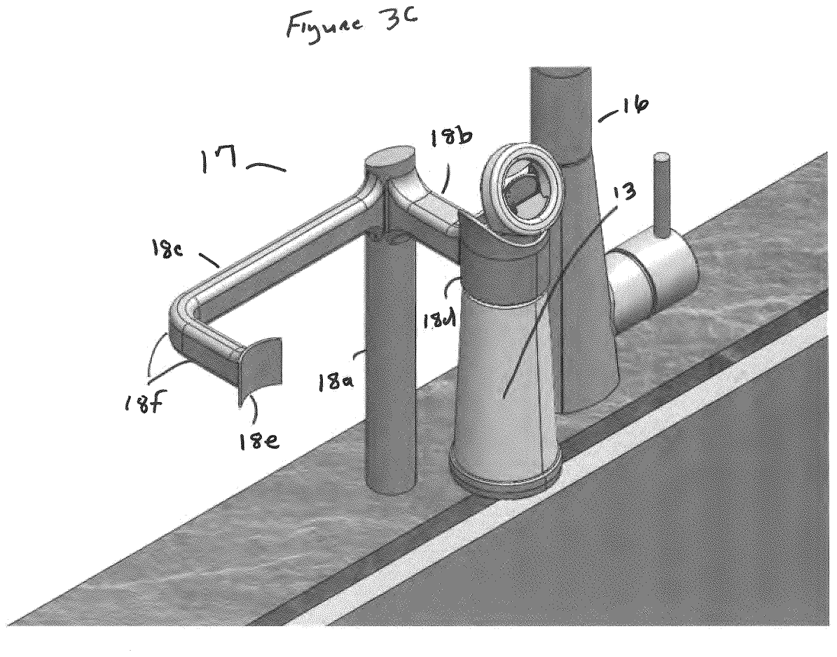

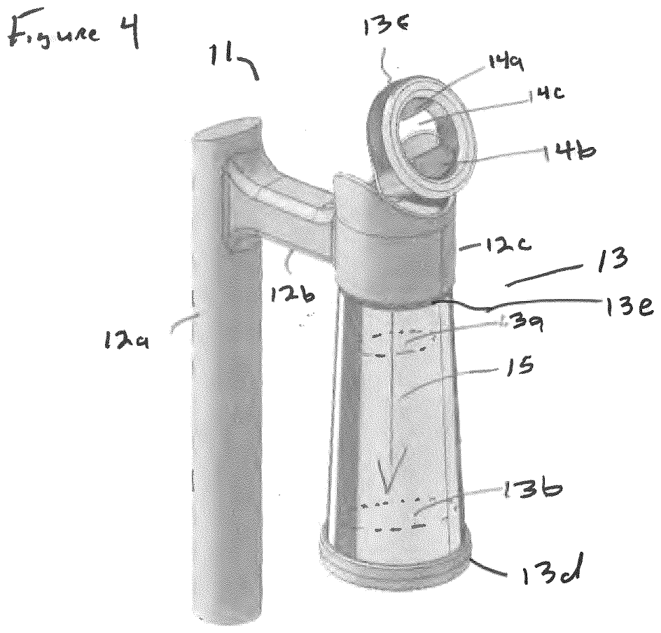

FIGS. 3A, 3B, 3C and 4 depict close-up views of support structures 11,17 according to exemplary embodiments.

Referring to FIG. 3A, in one embodiment the support structure 11 may comprise a pole 12a that may be substantially parallel with the faucet 16 when the structure 11 is configured close to the faucet 16, a first supporting arm 12b that is substantially perpendicular to the pole 12a and a first supportive ring 12c for supporting and holding a removable, threaded bottle cap storage compartment 13, for example. In an embodiment, the pole 12a, arm 12b and ring 12c may be composed of a stainless steel for example and the threaded storage compartment 13 may be cylindrical in shape and may be composed of a stainless steel or non-stainable plastic. Though the support structure 11 in the figures is shown with a single pole 12a, single arm 12b and single ring 12c, this is merely exemplary. In additional embodiments a support structure may comprise one or more poles, each of which may comprise one or more arms, where each arm further comprises one or more rings. Further, though only a single support structure 11 is shown attached to a kitchen counter-top 2b that is also exemplary. Alternatively, a plurality of support structures 11 may be attached to a counter-top 2b or another surface (e.g., restaurant or bar serving surface), for example.

For example, and with reference to FIGS. 3B and 3C, there is depicted an alternative embodiment of a second support structure 17 that includes a plurality of supporting arms and connected supporting rings. In an embodiment the support structure 17 may comprise a pole 18a that may be substantially parallel with the faucet 16 when the structure 17 is configured close to the faucet 16, a first supporting arm 18b and a second supporting arm 18c both of which may be connected substantially perpendicular to the pole 18a and connected such that their connections are separated from one another by an angle of 90 degrees for example, a first supportive ring 18d for supporting and holding a removable, threaded bottle cap storage compartment 13, for example, and a second supportive ring 18e for supporting and holding a second removable, bottle cap storage compartment or another holder (not shown). In an embodiment, the second supporting arm 18c may comprise a curved section 18f.

In an embodiment, the pole 18a, arms 18b,18c (and section 18f) and rings 18d,18e may be composed of a stainless steel, for example. It is noted that the ring 18e shown in FIG. 3B is depicted as a “half” ring in order to illustrate that each ring in FIGS. 3A, 3B and 3C may not be completely circular in shape.

Referring now to FIG. 4 there is depicted another view of the support structure 11. In an embodiment the removable, threaded storage compartment 13 may comprise a threaded top portion 13c (or “opener”) and threaded bottom portion 13d (or “storage” section; see threads 13e), where each portion may be threadably inserted into respective threads of the ring 12c (threads of the ring 12c not shown).

When the two portions 13c, 13d are connected the compartment 13 may be cylindrical and may have a tapered shape where the cross sectional diameter of the compartment is smaller on the top (e.g., at point 13a) than at the bottom (e.g., at point 13b). Said another way, the cross-sectional diameter of the compartment 13 may increase from top to bottom, for example. In an alternative embodiment the cross-sectional diameter may be the same from top to bottom, or yet alternatively, may increase from top to bottom of the compartment 13. One non-limiting example of dimensions for the diameter of compartment 13 are 2.5 inches at location 13b and 2.0 inches at location 13a.

To hold the compartment 13 in a vertical position the inside diameter of the ring 12c may be slightly larger than the maximum cross-sectional diameter of the top portion 13c of the compartment 13, but approximate to such a maximum cross sectional diameter that the top portion 13c may be threadably connected to the ring 12c..

As illustrated, the top portion or opener 13c may be shaped as a ring as well. Attached to the inside diameter of the opener 13c may be one or two pinching blades 14a, 14b that may be used to open a cap or cover of a bottle or another article (not shown) by placing the cap at an angle to one or more of the blades 14a,14b and applying an angular pressure to the cap. Upon applying such pressure the blades force the cap from the top of the bottle. Once separated from the bottle the cap may fall through an opening 14c between the blades 14a,14b and then downwards into the bottom or storage portion 13d of the compartment 13 as shown by arrow 15 in FIG. 4.

In an embodiment, to empty the compartment of caps, etc., the top portion 13c and/or bottom portion 13d may be threadably removed from the ring 12c.

In embodiments, the diameter of the ring 12c and the cross-sectional diameter of the compartment 13 may vary depending on the volume of the compartment 13. As noted previously, in one non-limiting embodiment the diameter of the compartment 13 may be tapered from 2.0 inches to 2,5 inches. In one embodiment the size of the compartment 13 may be as big as a beer glass (e.g., 6 inches in length and 2.0 to 2.5 inches in diameter.

While the compartment 13 shown in the figures includes an opener 13c as a top portion, this is merely exemplary. In yet another embodiment the top portion 13c of the compartment 13 may comprise a pivotable, hinged, or removable lid or cover on its top instead of an opener 13c in order to allow a cleaning article to be held within the compartment 13 (e.g., scrubber) to be stored within the compartment 13, for example. Alternatively, small food waste may be placed inside the compartment 13 for temporary storage before being emptied.

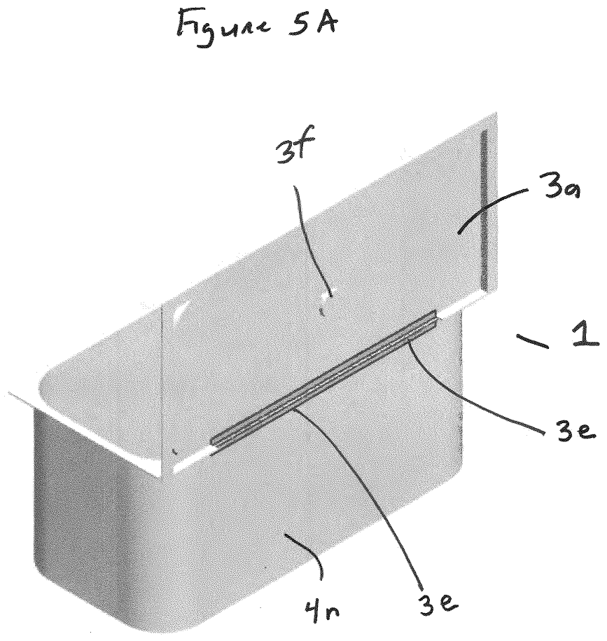

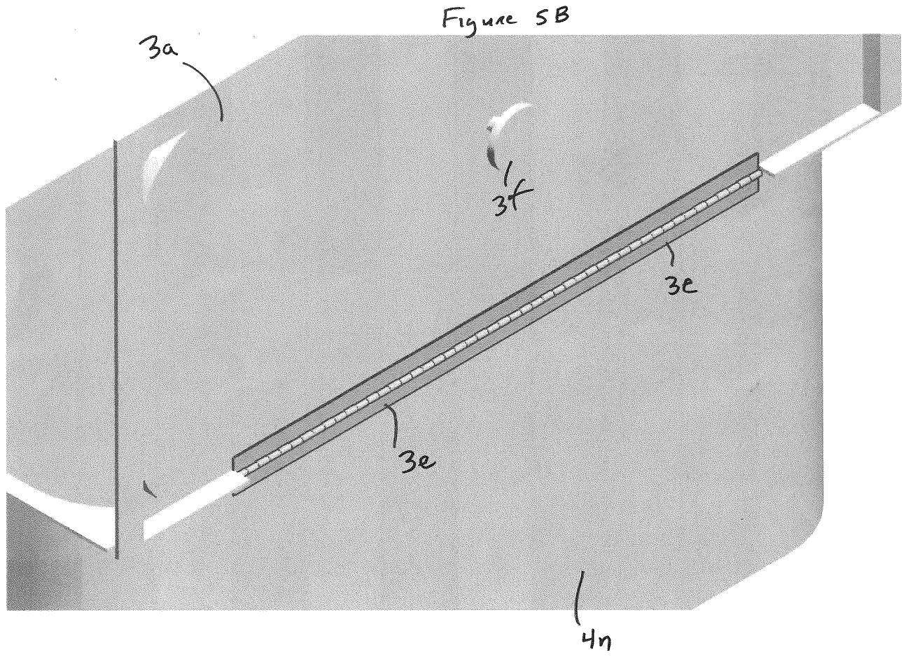

Referring now to FIGS. 5A and 5B there is depicted views of the hingeable top cover 3a according to an embodiment of the disclosure. As shown, a first side of the hinge 3e may be connected to the top cover 3a along one of the edges of the top cover 3a and a second side of the hinge 3e may be connected to one of the side walls, in this case side wall 4n though it should be understood that the hinge may be located on the opposite side wall 4b. Further, though the top cover 3a is shown as a one piece cover this is merely exemplary. Alternatively, the top cover may be a two piece cover, each piece being separately hingeably connected to one of the side walls 4a, 4c, for example. Top cover 3a may further comprise a handle 3f attached to the top cover 3a that allows a person to move the top cover 3a by grabbing the connected handle 3f, for example.

The claim language that follows below is incorporated herein by reference in expanded form, that is, hierarchically from broadest to narrowest, with each possible combination indicated by the multiple dependent claim references described as a unique standalone embodiment.

While benefits, other advantages, and solutions to problems have been described above with regard to specific embodiments of the present disclosure. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

I claim:

1. A removable food waste holder for a kitchen sink comprising:
a plurality of adjustable side walls, an adjustable bottom structure and an adjustable hingeable top cover forming a chamber to hold food waste, wherein the bottom structure comprises a plurality of openings to allow liquid to drain out of the holder and into the sink.

2. The removable food waste holder as in claim 1 wherein each of the plurality of adjustable side walls is composed of a stainless steel or a non-stainable plastic.

3. The removable food waste holder as in claim 1 wherein dimensions of each of the adjustable hingeable top cover, adjustable bottom structure, and adjustable side walls are variable in width, depth and/or length to allow the holder to fit within a kitchen sink.

4. The removable food waste holder as in claim 1 wherein the holder comprises dimensions of 8″ in width, 7″ in depth and 171/2″ in length or 6″ in width, 6″ in depth and 151/2 in length.

5. The removable food waste holder as in claim 1 further comprising one or more curved sub-walls.

6. The removable food waste holder as in claim 1 wherein the holder is rectangular shaped.

7. The removable food waste holder as in claim 1 wherein the holder is shaped as a square, oval, or circular.

8. The removable food waste holder as in claim 1 wherein one or more of the side walls comprise a top, circumferential adjustable rim portion configured to rest upon ridges of the kitchen sink.

9. The removable food waste holder as in claim 8 wherein the rim portion comprises a width of one inch.

10. A method for collecting food waste within a kitchen sink comprising:
inserting a food waste holder into a kitchen sink, the holder comprising a plurality of side walls, a bottom and a hingeable top forming a chamber to hold food waste, wherein the bottom comprises a plurality of openings to allow liquid to drain out of the holder and into the sink;
lifting the holder; and
allowing the liquid to drain out of the openings and emptying the chamber.

11. A support structure attached to a kitchen counter-top comprising:
at least one supporting pole, one or more supporting arms connected to the at least one pole;
at least one supporting ring connected to each supporting arm; and
at least one compartment supported by each of the rings for holding bottle caps, scrubbers, and/or food waste.

12. The support structure as in claim 11 wherein the compartment comprises a threaded bottle cap storage compartment.

13. The support structure as in claim 11 wherein the pole, arm and ring are composed of a stainless steel.

14. The support structure as in claim 12 wherein the threaded storage compartment is cylindrical in shape.

15. The support structure as in claim 12 wherein the threaded storage compartment and may be composed of a stainless steel or non-stainable plastic.

16. A method for supporting a compartment attached to a kitchen counter-top comprising:
connecting at least one structure to a kitchen counter-top, the structure comprising at least one supporting pole, one or more supporting arms connected to the at least one pole and at least one supporting ring connected to each arm, and
connecting at least one compartment to each of the rings to hold bottle caps, scrubbers and/or food waste.
